(19) United States
(12) Patent Application Publication
(10) Pub. No.: US 2009/0303253 A1
(43) Pub. Date: Dec. 10, 2009

(54) PERSONALIZED SCALING OF INFORMATION

(75) Inventors: Gary W. Flake, Bellevue, WA (US); Blaise Aguera y Arcas, Seattle, WA (US); Brett D. Brewer, Sammamish, WA (US); Anthony T. Chor, Bellevue, WA (US); Steven Drucker, Bellevue, WA (US); Karim Farouki, Seattle, WA (US); Ariel J. Lazier, Seattle, WA (US); Stephen L. Lawler, Redmond, WA (US); Richard Stephen Szeliski, Bellevue, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/133,756

(22) Filed: Jun. 5, 2008

(51) Int. Cl. G09G 5/38

(52) U.S. Cl. 345/660

(57) ABSTRACT

The claimed subject matter provides a system and/or a method that facilitates rendering of a portion of viewable data. A web page, a user interface or other displayable information can be personalized such that disparate portions of the displayable information are rendered at varying scales, resolutions, sizes, etc. A personalizer can generate personalization data related to a user. The personalization data can include a display property associated with a portion of viewable data. In addition, a display engine is provided that displays the portion of viewable data based upon the personalization data and display property.

### BACKGROUND

Conventionally, browsing experiences related to web pages or other web-displayed content are comprised of images or other visual components of a fixed spatial scale, generally based upon settings associated with an output display screen resolution and/or the amount of screen real estate allocated to a viewing application, e.g., the size of a browser that is displayed on the screen to the user. In other words, displayed data is typically constrained to a finite or restricted space correlating to a display component (e.g., monitor, LCD, etc.).

In general, the presentation and organization of data (e.g., the Internet, local data, remote data, websites, etc.) directly influences one's browsing experience and can affect whether such experience is enjoyable or not. For instance, a website with data aesthetically placed and organized tends to have increased traffic in comparison to a website with data chaotically or randomly displayed. Moreover, interaction capabilities with data can influence a browsing experience. For example, typical browsing or viewing data is dependent upon a defined rigid space and real estate (e.g., a display screen) with limited interaction such as selecting, clicking, scrolling, and the like.

While published content, web pages, or other web-displayed content have created clever ways to attract a user's attention even with limited amounts of screen real estate, there exists a rational limit to how much information can be supplied by a finite display space—yet, a typical user usually necessitates a much greater amount of information be provided to the user. Additionally, a typical user prefers efficient use of such limited display real estate. For instance, most users maximize browsing experiences by resizing and moving windows within display space.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

With advance browsing features (e.g., seamless panning and zooming, etc.), display capabilities are greatly enhanced for web pages, thumbnails, and other displayed data. For instance, a typical web page or user interface has a finite amount of screen real estate, wherein a web page or user interface can have virtually unlimited real estate by zooming in, zooming out, panning, and the like in a seamless cohesive manner. These dynamic views can quickly change or distort displayed data on a web page or user interface such as thumbnails, graphics, logos, trademarks, etc.

The subject innovation includes a personalization component that enables a portion of viewable data (e.g., web page, user interface, etc.) to be viewed with defined parameters (e.g., a consistent resolution, scale factor, size, reflow parameters, priority, etc.) corresponding to personalization data. The personalization data can include a display property that defines parameters (e.g., resolutions, priorities, visibility, etc.) for viewable data. The personalization data and the display property can be determined by user preferences ascertained through monitoring user interactions. Thus, viewable data can be viewed by a particular user at disparate view levels in accordance to the display property definitions regardless of original or default view-levels or view locations (e.g., location on a particular view-level) within a web page, user interface, etc. In other aspects of the claimed subject matter, methods are provided that facilitate displaying a portion of viewable in accordance with display parameters defined within personalization data, wherein the display parameters dictate visibility, scaling factors, reflow parameters, priority, author/designer views, etc.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates personalizing a portion of viewable data at a particular view-level in accordance with inferred or specified preferences.

FIG. 2 illustrates a block diagram of an exemplary system that facilitates producing personalization data that can be employed to personalize viewable content.

FIG. 3 illustrates a block diagram of an exemplary system that facilitates displaying a portion of viewable data having two or more view levels associated with a portion of image data.

FIG. 4 illustrates a block diagram of an exemplary system that facilitates rendering a portion of viewable data based upon personalized data defining parameters for particular view-levels.

FIG. 5 illustrates a block diagram of exemplary system that facilitates enhancing implementation of rendering viewable data in accordance with personalization data with a display technique, a browse technique, and/or a virtual environment technique.

FIG. 6 illustrates a block diagram of an exemplary system that facilitates utilizing personalization data to define view-level display properties for viewable data.

FIG. 7 illustrates an exemplary methodology for displaying a portion of viewable data at a particular view-level in accordance with personalization data.

FIG. 8 illustrates an exemplary methodology that facilitates rendering a portion of published content within a browsing session based upon personalization data.

FIG. 9 illustrates an exemplary networking environment, wherein the novel aspects of the claimed subject matter can be employed.

FIG. 10 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “obtainer,” “personalizer,” “analyzer,” “generator,” “store,” “engine,” “aggregator,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

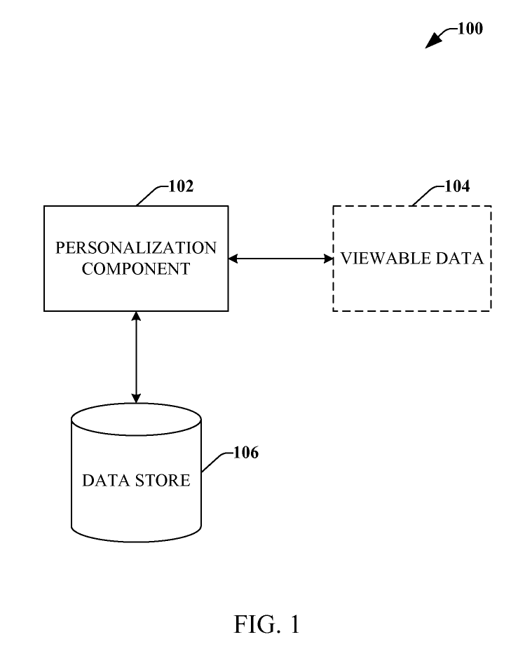

Now turning to the figures, FIG. 1 illustrates a system 100 that facilitates personalizing a portion of viewable data at a particular view-level in accordance with inferred or specified preferences. The system 100 can include a personalization component 102 that enables a portion of viewable data 104 to be displayed based upon display parameters personalized for at least one user. In particular, the parameters can define a view-level display property (e.g., a priority, a resolution, a visibility attribute, a scale/size factor, an optimal view, a reflow definition, etc.), wherein the personalization component 102 can enforce the display of the portion of viewable data 104 based upon the parameters. Moreover, the personalization component 102 can graphically construct a portion of viewable data (based upon the personalized parameters) which can be displayed or rendered. In other words, a view-level can be established on the portion of viewable data 104 according to preferences of at least one user perceiving the viewable data 104. This, in turn, enables viewable data 104 (e.g., web pages, web sites, documents, files, text, graphics, data, articles, photographs, etc.) to be displayed as desired by a user or group of users.

The viewable data 104 can include any content presentable on a display. For example, the viewable data 104 can be web pages, application user interfaces, operating system user interfaces, text documents, images, photographs, graphics, files, and the like. The personalization component 102 can generate personalization data that defines, at least in part, how the viewable data 104 is displayed to a user corresponding to the personalization data. Pursuant to an illustration, the personalization data can include user preference data, user interest data (e.g., topics, subject matter, etc., that interest a user), user historical data (e.g., actions, behaviors, patterns of a user observed over time) and the like. In addition, the personalization data can include specific instructions (e.g., display properties) relating to how the preference data is to be applied in displaying or rendering the viewable data 104. The personalization data can be utilized to define various display properties of the viewable data 104. The viewable data 104 can be displayed or rendered at various view levels. In particular, the personalization data can define view level display properties such as, but not limited to, a visibility attribute for a particular view-level (e.g., display a portion of viewable data or not at a view-level), a resolution at a particular view-level, a priority at a specific view-level, a scale/size factor for a view-level (e.g., shrink or grow factor between view-levels or size definition at a view-level), a reflow definition for a particular view-level (e.g., layout for viewable data upon an adjustment of available display real estate), an optimal view or organization of content at a particular view-level (e.g., author-defined views/layouts for a view-level, pre-defined viewing experiences, user personalization, etc.), and the like.

The system 100 can further include a data store 106 that can include any suitable data related to the personalization component 102, the viewable data 104, etc. For example, the data store 106 can include, but not limited to including, personalization data, user histories, definitions for applying personalization data, priority data related to a portion of viewable data, resolution data related to a portion of viewable data, scale/size factor data related to a portion of viewable data, visibility data related to a portion of viewable data (e.g., whether to display data or not to display data), reflow parameters related to a portion of viewable content, user profiles, user preferences for display, user defined settings, usernames and passwords, etc. For example, the personalization component 102 can receive an instruction to personalize a portion of viewable data and read/display personalization data or user preferences related to such viewable data to define view-level display properties. In other words, the data store 106 can store personalization data and/or definitions that correspond to viewable data, users, etc. It is to be appreciated that the data store 106 can be local, remote, associated in a cloud (e.g., a collection of resources that can be remotely accessed by a user, etc.), and/or any suitable combination thereof.

It is to be appreciated that the data store 106 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 106 of the subject systems and methods is intended to comprise, without being limited to, these and any other suitable types of memory. In addition, it is to be appreciated that the data store 106 can be a server, a database, a hard drive, a pen drive, an external hard drive, a portable hard drive, and the like.

In addition, the system 100 can include any suitable and/or necessary interface component (not shown), which provides various adapters, connectors, channels, communication paths, etc. to integrate the personalization component 102 into virtually any operating and/or database system(s) and/or with one another. In addition, the interface component can provide various adapters, connectors, channels, communication paths, etc., that provide for interaction with the personalization 102, the viewable data 104, the data store 106, and any other device and/or component associated with the system 100.

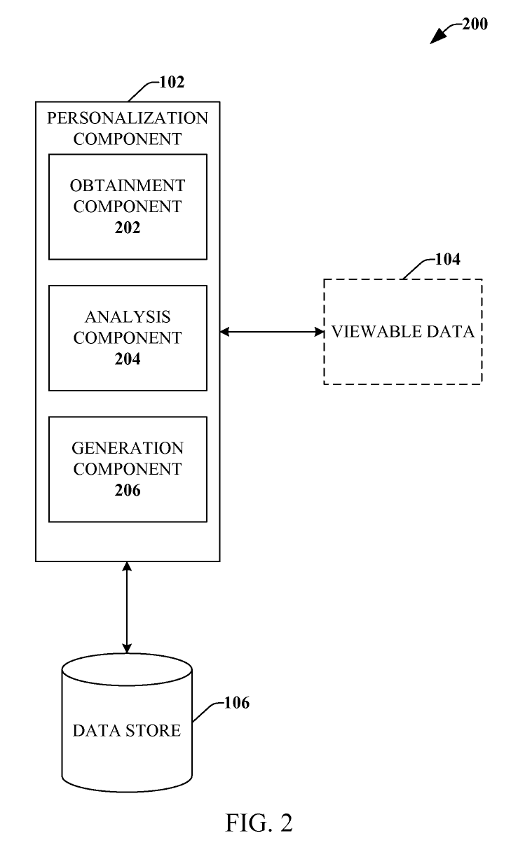

FIG. 2 illustrates a system 200 that facilitates producing personalization data that can be employed to personalize viewable content. The system 200 can include a personalization component 102 that evaluates personalization data. The personalization data can be utilized to adjust how the viewable data 104 is displayed or rendered to a user. For example, the personalization data can indicate that a portion of viewable data is to be scaled up relative to other portions, rendered with more detail, organized to a more prominent location, etc. The system 200 can further include a data store 106 that can retain the personalization data or any other data as described supra.

The personalization component 102 can include an obtainment component 202 that can collect data about a user employable for personalization. For example, the obtainment component 202 can observe a user to determine frequency of interaction with a particular aspect of viewable data, a topic or subject matter of displayed content, and the like. For instance, the obtainment component 202 can ascertain a number of times a user utilizes a particular application icon, user interface element, bookmark etc. In addition, the obtainment component 202 can observe a number of times a user reviews content (e.g., a document, web page, article, etc.) on a particular subject. Further, the obtainment component 202 can collect data on duration of interactions. Pursuant to an illustration, the obtainment component 202 can observe that a user interacts with a particular application or user interface element for extended periods of time. In addition, a user can view content for a long period of time, which provides an indication of interest. According to another aspect, the obtainment component 202 can gather information related to a group or community of users. For example, the obtainment component 202 can monitor social networks to ascertain other users a particular user engages with, regular topics of discussions among a plurality of users, common interests, etc.

The personalization component 102 can further include an analysis component 204 that analyzes the information collected by the obtainment component 202. The analysis component 204 evaluates the information to determine preferences of the user (e.g., what the user likes and dislikes), favorite applications, gadgets, topics, functionality, and the like. For example, if the collection information shows that a user frequently interacts with a particular widget or gadget for extended periods of time, the analysis component 204 can infer that the user favors that widget. Pursuant to another example, if a user often peruses articles or content on lacrosse, the analysis component 204 can determine that the user is interested in lacrosse.

According to another aspect, the personalization component 102 can include a generation component 206 that produces personalization data. Personalization data can include display properties or parameters that define how to display or render viewable data 104 according to a user's personalized tastes. For instance, the generated personalization data can include display properties that specify that the favored widget is scaled larger than other widgets. Pursuant to another illustration, aggregated content can be scaled and/or reorganized according to topics of interest encoded in display properties/personalization data. For example, a list of feed articles or a news site can be rendered to highlight a new article on a topic of interest.

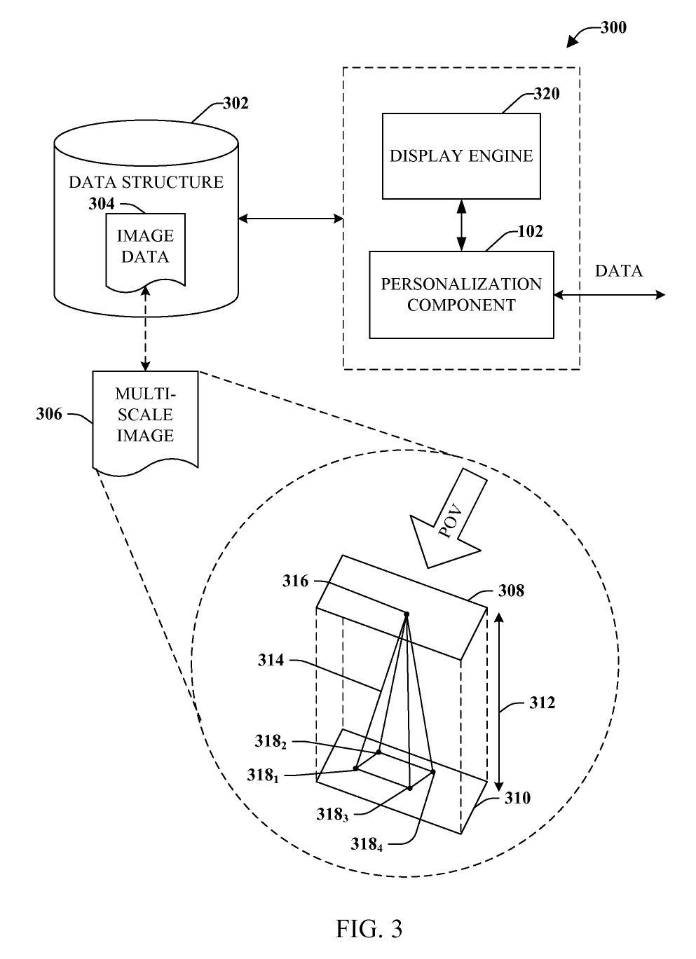

FIG. 3 illustrates a system 300 that facilitates displaying a portion of viewable data having two or more view levels associated with a portion of image data. The system 300 can include the personalization component 102 that can receive information related to user interactions, patterns, interests etc., to generate personalization data. The personalization data can relate to displaying viewable data at various view levels and/or resolutions. In other words, the personalization component 102 can enable a portion of viewable data to be displayed at a particular view-level in accordance with user preferences. In general, a user can utilize the personalization component 102 as a tool to define view-level display properties for viewable data, wherein the display properties can include view-level changes or size changes (e.g., zoom in, zoom out, pan, etc.). For example, the personalization data for a user can dictate how to render viewable data at various view levels.

Generally, system 300 can include a data structure 302 with image data 304 that can represent, define, and/or characterize computer displayable multi-scale image 306, wherein a display engine 320 can access and/or interact with at least one of the data structure 302 or the image data 304 (e.g., the image data 304 can be any suitable data that is viewable, displayable, and/or browse able). In particular, image data 304 can include two or more substantially parallel planes of view (e.g., layers, scales, view-levels, etc.) that can be alternatively displayable, as encoded in image data 304 of data structure 302. For example, image 306 can include first plane 308 and second plane 310, as well as virtually any number of additional planes of view, any of which can be displayable and/or viewed based upon a level of zoom 312. For instance, planes 308, 310 can each include content, such as on the upper surfaces that can be viewable in an orthographic fashion. At a higher level of zoom 312, first plane 308 can be viewable, while at a lower level zoom 312 at least a portion of second plane 310 can replace on an output device what was previously viewable.

Moreover, planes 308, 310, et al., can be related by pyramidal volume 314 such that, e.g., any given pixel in first plane 308 can be related to four particular pixels in second plane 310. It should be appreciated that the indicated drawing is merely exemplary, as first plane 308 need not necessarily be the top-most plane (e.g., that which is viewable at the highest level of zoom 312), and, likewise, second plane 310 need not necessarily be the bottom-most plane (e.g., that which is viewable at the lowest level of zoom 312). Moreover, it is further not strictly necessary that first plane 308 and second plane 310 be direct neighbors, as other planes of view (e.g., at interim levels of zoom 312) can exist in between, yet even in such cases the relationship defined by pyramidal volume 314 can still exist. For example, each pixel in one plane of view can be related to four pixels in the subsequent next lower plane of view, and to 316 pixels (a vertex of pyramidal volume 314) in the next subsequent plane of view, and so on. Accordingly, the number of pixels included in pyramidal volume at a given level of zoom, l, can be described as p=4^{l}, where l is an integer index of the planes of view and where l is greater than or equal to zero. It should be appreciated that p can be, in some cases, greater than a number of pixels allocated to image 306 (or a layer thereof) by a display device (not shown) such as when the display device allocates a relatively small number of pixels to image 306 with other content subsuming the remainder or when the limits of physical pixels available for the display device or a viewable area is reached. In these or other cases, p can be truncated or pixels described by p can become viewable by way of panning image 306 at a current level of zoom 312.

However, in order to provide a concrete illustration, first plane 308 can be thought of as a top-most plane of view (e.g., l=0) and second plane 310 can be thought of as the next sequential level of zoom 312 (e.g., l=1), while appreciating that other planes of view can exist below second plane 310, all of which can be related by pyramidal volume 314. Thus, a given pixel in first plane 308, say, pixel 316, can by way of a pyramidal projection be related to pixels 318₁-318₄ in second plane 310. The relationship between pixels included in pyramidal volume 314 can be such that content associated with pixels 318₁-318₄ can be dependent upon content associated with pixel 316 and/or vice versa. It should be appreciated that each pixel in first plane 308 can be associated with four unique pixels in second plane 310 such that an independent and unique pyramidal volume can exist for each pixel in first plane 308. All or portions of planes 308, 310 can be displayed by, e.g. a physical display device with a static number of physical pixels, e.g., the number of pixels a physical display device provides for the region of the display that displays image 306 and/or planes 308, 310. Thus, physical pixels allocated to one or more planes of view may not change with changing levels of zoom 312; however, in a logical or structural sense (e.g., data included in image data 304) each success lower level of zoom 312 can include a plane of view with four times as many pixels as the previous plane of view.

Moreover, it is to be appreciated that the pyramidal volume need not follow a linear progression as described above. For example, a first pixel at view level or first plane 308 can relate to four particular pixels on view level or second plane 310 while a second pixel at the first plane 308 can relate to 64 pixels on the second plane 310. Thus, each pixel on a given view level can be associated with a unique and/or independent pyramidal volume that follows a variety of progressions. Pursuant to another illustration, a pixel at plane 308 can be associated with four pixels on the second plane 310. Any of the four pixels at the second plane 310 can then be associated with different numbers of pixels at lower levels. For example, one pixel can be associated with 8 pixels while another pixel can relate to 16. In addition, a pixel on view level 308 can correspond to an image or graphical data type. However, on view level 310, the pixel can transition into a different data type. For instance, a level of zoom 312 can include a plane of view that includes video or animation associated with a pixel at a previous plane of view.

The image data 304 and/or the various planes of view related to the multi-scale image 306 can be associated with personalization data that defines at least one view-level display property. It is to be appreciated that the image data 304 and/or the multi-scale image 306 can be a portion of viewable data that can be rendered or displayed to a user. For example, the personalization component 102 can further enforce view-level display properties for the image data 304 and/or the multi-scale image 306 in connection with a view-level navigated and/or explored with viewable data. In particular, the personalization component 102 can generate personalization data based at least in part on observed user behavior or patterns. The display engine 320 can receive view-level display properties from personalization data, wherein such data can relate to the image data 304 and/or the multi-scale image 306. Moreover, the personalization data can include definitions that can be utilized by the display engine 320 for rendering of viewable data in accordance therewith. As discussed, the personalization data can include view-level display properties such as, but not limited to, a visibility attribute for a particular view-level (e.g., display a portion of content or not at a view-level), a resolution at a particular view-level, a priority at a specific view-level, a scale/size factor for a view-level (e.g., shrink or grow factor between view-levels or size definition at a view-level), a reflow definition for a particular view-level (e.g., layout for content upon an adjustment of display real estate), an optimal view or organization of content at a particular view-level (e.g., author-defined views/layouts for a view-level), and the like.

It is to be appreciated that the tag can define view-level properties for a portion of view-levels, a subset of view-levels, a boundary of view-levels, or all views or view-levels (e.g., planes of view) for the image data 304 and/or the multi-scale image 306. In other words, a tag can correspond to the image data 304 and/or the multi-scale image 306 which defines a plurality of view-level display properties at various levels or planes of view. In addition, it is to be appreciated that the personalization data can be associated with any suitable image data 304 (having multi-scale image with pyramidal volumes of data at various view levels or planes of view) or a portion of published content (viewed with the ability to zoom in, zoom out, pan, etc. on content) in at least one of a 2-dimensional (2D) environment or a 3-dimensional (3D) environment. In other words, it is to be appreciated that the personalization component 102 can be utilized with image data or content having pyramidal volumes of data (as described with image data 304 and multi-scale image 306) as well as single-plane data as conventionally browsed on the Internet, a network, a wireless network, and the like.

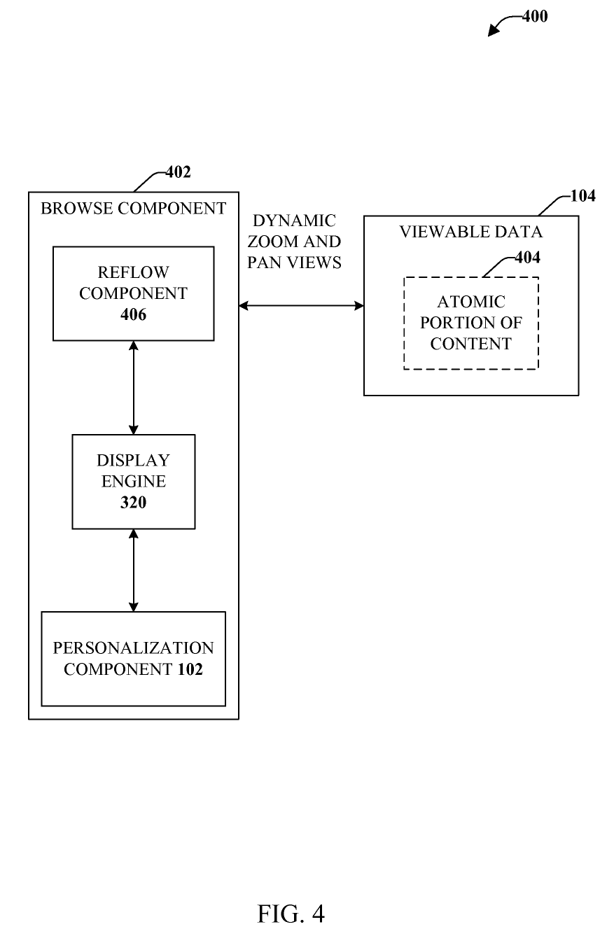

FIG. 4 illustrates a system 400 that facilitates rendering a portion of viewable data based upon personalized data defining parameters for particular view-levels. The system 400 can include the personalization component 102 that can generate personalization data for viewable data 104 in order to display such viewable data in accordance with view-level properties defined in the personalization data. The system 400 can further include a browse component 402 that can leverage the display engine 320 and/or the personalization 102 in order to allow interaction or access with the viewable data 104 across a network, server, the web, the Internet, cloud, and the like. The browse component 402 can receive navigation data (e.g., instructions related to navigation within data or published content, view level location, location within a particular view level, etc.), wherein such navigation data can direct to published content with respective tags having view-level display definitions. In other words, the browse component 402 can leverage the display engine 320 and/or the personalization component 102 to enable viewing or displaying viewable data 104 at a view level based upon personalization data. For example, the browse component 402 can receive personalization data that defines a particular view-level within the viewable data 104 in which a portion of atomic content 406 can be displayed based upon a view-level associated with the personalization data. It is to be appreciated that the browse component 402 can be any suitable data browsing component such as, but not limited to, a portion of software, a portion of hardware, a media device, a mobile communication device, a laptop, a browser application, a smart phone, a portable digital assistant (PDA), a media player, a gaming device, and the like.

As discussed, the personalization data can include at least one view-level display property such as, but not limited to a visibility attribute for a particular view-level (e.g., display a portion of content or not display based upon a navigated view-level within the browsing session), a resolution at a particular view-level (e.g., defining the resolution for display for a portion of atomic content based upon a navigated view-level), a priority at a specific view-level (e.g., priority for displaying content based on view-level or navigated location), a scale/size factor for a view-level (e.g., shrink or grow factor between view-levels or size definition at a view-level), a reflow definition for a particular view-level (e.g., layout for content upon an adjustment of display or screen real estate), an optimal view or organization of content at a particular view-level (e.g., author-defined views/layouts for a view-level), etc.

For example, the personalization can define a visibility attribute for a portion of atomic content. The visibility attribute can define whether a portion of data is displayed or not displayed. Viewable data 104 can include all data presented on a display. However, it is to be appreciated that such data can be separable or delineated into smaller portions until an atomic unit is encountered. The atomic unit can be a pixel, a group of pixel, an image, a letter of text, a word of text, a sentence of text, a paragraph of text, etc. The personalization data can further define a resolution for the portion of atomic content. For instance, a web site can include a portion of text in which a respective personalized data can dictate a resolution for such text within various view-levels (e.g., planes of view, etc.) and/or particular areas or locations within such web site. Moreover, the personalization can include information related to a priority for the portion of atomic content 404 (e.g., priority for displaying content based on user preferences). The portion of atomic content 404 can be any portion of viewable data 104 that can be scaled and/or zoomed independently of other content in the viewable data 104. For example, the portion of atomic content 404 can be an icon in an operating system, a toolbar button in a user interface, a graphic on a web site, an article on a web site, etc.

The personalization data can further include a reflow definition for a particular view-level (e.g., layout for content upon an adjustment of display or screen real estate). A reflow can be a re-structuring or re-organization of a viewable data based upon an adjustment of screen real estate or display area for such viewable data, wherein such re-structuring or re-organization of content enables optimal viewing in terms of display or real estate. For example, a web page can include text and a picture in which a full screen view displays the text and picture fully. Yet, an adjustment of the viewing pane or window can enable a reflow to occur, wherein the reflow can adjust the picture and/or text size and/or placement to optimize use of the new viewing pane or window measurements. Thus, a resize of a window browsing session can be “reflowed” in order to allow the browsing session to be enhanced for display.

Accordingly, the system 400 can include a reflow component 406 that enables the viewable data 402 to be “reflowed” in accordance to the defined parameters and/or attributes within personalization data. The reflow component 406 can generate a re-organization or re-structuring of viewable based upon the reflow definition for such viewable data. For instance, a first view-level can include a first reflow layout for a particular resizing of display real estate, whereas a second view-level can include a second reflow layout for another display real estate measurement. It is to be appreciated that the reflow component 406 is depicted as a stand-alone component within the browse component 402, yet the reflow component 406 can be incorporated into the display engine 320, incorporated into the personalization component 102, a stand-alone component separate of the browse component 402, and/or any suitable combination thereof.

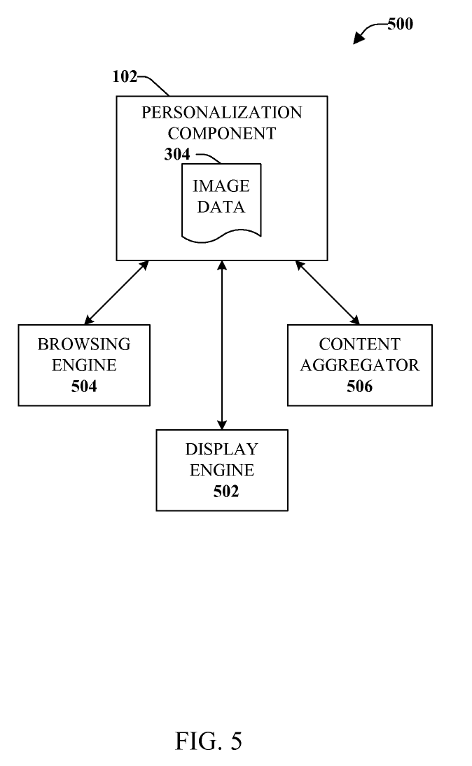

FIG. 5 illustrates a block diagram of exemplary system that facilitates enhancing implementation of rendering viewable data in accordance with personalization data with a display technique, a browse technique, and/or a virtual environment technique. The system 500 can include the personalization component 102 and/or a portion of image data 304 as described above. The system 500 can further include a display engine 502 that enables seamless pan and/or zoom interaction with any suitable displayed data or published content, wherein such data can include multiple scales or views and one or more resolutions associated therewith. In other words, the display engine 502 can manipulate an initial default view for displayed data by enabling zooming (e.g., zoom in, zoom out, etc.) and/or panning (e.g., pan up, pan down, pan right, pan left, etc.) in which such zoomed or panned views can include various resolution qualities. The display engine 502 enables visual information to be smoothly browsed regardless of the amount of data involved or bandwidth of a network. Moreover, the display engine 502 can be employed with any suitable display or screen (e.g., portable device, cellular device, monitor, plasma television, etc.). The display engine 502 can further provide at least one of the following benefits or enhancements: 1) speed of navigation can be independent of size or number of objects (e.g., data); 2) performance can depend on a ratio of bandwidth to pixels on a screen or display; 3) transitions between views can be smooth; and 4) scaling is near perfect and rapid for screens of any resolution.

For example, an image can be viewed at a default view with a specific resolution. Yet, the display engine 502 can allow the image to be zoomed and/or panned at multiple views or scales (in comparison to the default view) with various resolutions. Thus, a user can zoom in on a portion of the image to get a magnified view at an equal or higher resolution. By enabling the image to be zoomed and/or panned, the image can include virtually limitless space or volume that can be viewed or explored at various scales, levels, or views with each including one or more resolutions. In other words, an image can be viewed at a more granular level while maintaining resolution with smooth transitions independent of pan, zoom, etc. Moreover, a first view may not expose portions of information or data on the image until zoomed or panned upon with the display engine 502.

A browsing engine 504 can also be included with the system 500. The browsing engine 504 can leverage the display engine 502 to implement seamless and smooth panning and/or zooming for any suitable data browsed in connection with at least one of the Internet, a network, a server, a website, a web page, and the like. It is to be appreciated that the browsing engine 504 can be a stand-alone component, incorporated into a browser, utilized with in combination with a browser (e.g., legacy browser via patch or firmware update, software, hardware, etc.), and/or any suitable combination thereof. For example, the browsing engine 504 can be incorporate Internet browsing capabilities such as seamless panning and/or zooming to an existing browser. For example, the browsing engine 504 can leverage the display engine 502 in order to provide enhanced browsing with seamless zoom and/or pan on a website, wherein various scales or views can be exposed by smooth zooming and/or panning.

The system 500 can further include a content aggregator 506 that can collect a plurality of two dimensional (2D) content (e.g., media data, images, video, photographs, metadata, trade cards, etc.) to create a three dimensional (3D) virtual environment that can be explored (e.g., displaying each image and perspective point). In order to provide a complete 3D environment to a user within the virtual environment, authentic views (e.g., pure views from images) are combined with synthetic views (e.g., interpolations between content such as a blend projected onto the 3D model). For instance, the content aggregator 506 can aggregate a large collection of photos of a place or an object, analyze such photos for similarities, and display such photos in a reconstructed 3D space, depicting how each photo relates to the next. It is to be appreciated that the collected content can be from various locations (e.g., the Internet, local data, remote data, server, network, wirelessly collected data, etc.). For instance, large collections of content (e.g., gigabytes, etc.) can be accessed quickly (e.g., seconds, etc.) in order to view a scene from virtually any angle or perspective. In another example, the content aggregator 506 can identify substantially similar content and zoom in to enlarge and focus on a small detail. The content aggregator 506 can provide at least one of the following: 1) walk or fly through a scene to see content from various angles; 2) seamlessly zoom in or out of content independent of resolution (e.g., megapixels, gigapixels, etc.); 3) locate where content was captured in relation to other content; 4) locate similar content to currently viewed content; and 5) communicate a collection or a particular view of content to an entity (e.g., user, machine, device, component, etc.).

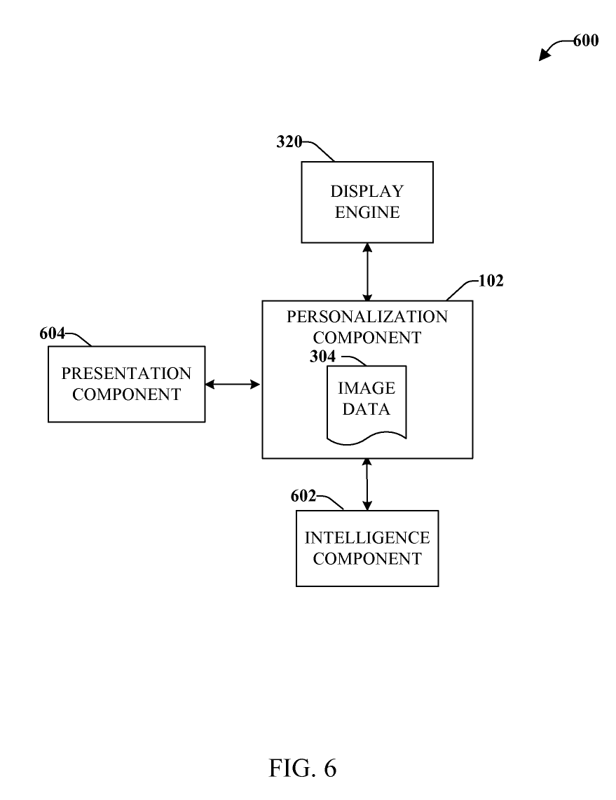

FIG. 6 illustrates a system 600 that employs intelligence to facilitate utilizing personalization data to define view-level display properties for viewable data. The system 600 can include the personalization data 102 and a portion of viewable data which can be substantially similar to respective personalization components and data described in previous figures. The system 600 further includes an intelligence component 602. The intelligence component 602 can be utilized by the personalization component 102 to facilitate rendering a portion of data in accordance with view-level display properties defined based upon inferred personalization data. For example, the intelligence component 602 can infer view-level display properties, user preferences, author preferences for defining view-level display properties, user hardware optimal settings in connection with personalization data, reflow layouts, user preferences related to reflow re-organizations, reflow settings associated with hardware/resource capabilities, optimal views based upon historic data related to an user, etc.

The intelligence component 602 can employ value of information (VOI) computation in order to identify view-level display properties to enforce for a portion of viewable data. For instance, by utilizing VOI computation, the most ideal and/or appropriate view-level display properties for a particular user can be determined. Moreover, it is to be understood that the intelligence component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

The personalization component 102 can further utilize a presentation component 604 that provides various types of user interfaces to facilitate interaction between a user and any component coupled to the personalization component 102. As depicted, the presentation component 604 is a separate entity that can be utilized with the personalization component 102. However, it is to be appreciated that the presentation component 604 and/or similar view components can be incorporated into the personalization component 102 and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into personalization component 102.

The user can also interact with the regions to select and provide information via various devices such as a mouse, a roller ball, a touchpad, a keypad, a keyboard, a touch screen, a pen and/or voice activation, a body motion detection, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, EGA, VGA, SVGA, etc.) with limited graphic support, and/or low bandwidth communication channels.

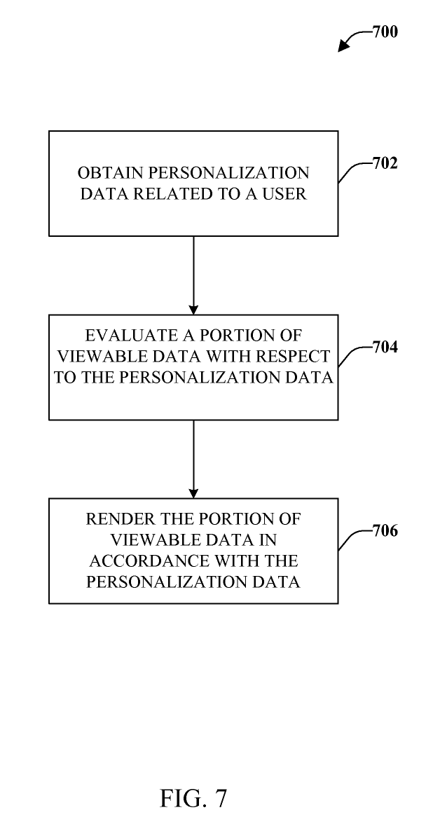

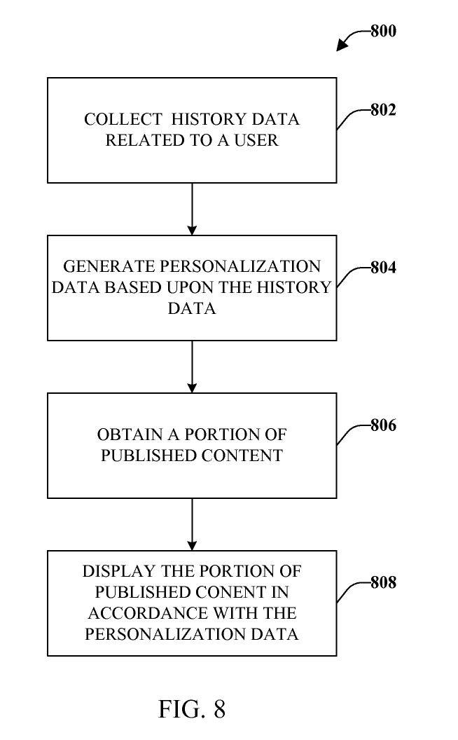

FIGS. 7-8 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a method 700 that facilitates displaying a portion of viewable data at a particular view-level in accordance with personalization data. At reference numeral 702, personalization data related to at least one user is obtained. The personalization data can include data related to likes and dislikes of the user, favored applications, favored interface elements, etc. At reference numeral 704, a portion of viewable data can be evaluated. The portion of viewable can be any suitable data that can be viewed, displayed, browsed, navigated, explored, and the like. For example, the viewable data can be a web page, a web site, a portion of a user interface (e.g., operating system and/or application interface), a portion of a web page, a portion of a web site, a portion of a graphic, a picture, a photograph, a portion of text, a portion of audio, a portion of video, a portion of a photograph, a document (e.g., word processing document, a graphic design document, a technical drawing document, a slide show document, etc.), a file (e.g., a thumbnail, a tile representation, etc.), a data file, an article, etc. Moreover, the evaluation of the portion of viewable data can include analysis related to metadata, markup language information, tags, and the like.

At reference numeral 706, the portion of viewable data can be rendered based upon the evaluation and the personalization data. For example, the personalization data can indicate at least one view-level display property associated with the portion of viewable data. The view-level display property can be, but is not limited to being, a visibility attribute for a particular view-level (e.g., display a portion of content or not display based upon personalization), a resolution at a particular view-level (e.g., defining the resolution for display for a portion of data based upon a navigated view-level), a priority at a specific view-level (e.g., priority for displaying content based on view-level or navigated location), a scale/size factor for a view-level (e.g., shrink or grow factor between view-levels or size definition at a view-level), a reflow definition for a particular view-level (e.g., layout for content upon an adjustment of display or screen real estate), and/or an optimal view or organization of content at a particular view-level (e.g., author-defined views/layouts for a view-level).

FIG. 8 illustrates a method 800 for rendering a portion of published content within a browsing session based upon personalization data. At reference numeral 802, history information related to a user collected. For instance, a user can be observed to determine frequency of interaction with particular content, a topic or subject matter of displayed content, and the like. At reference numeral 804, personalization data can be generated based at least in part upon the history data.

At reference numeral 806, a portion of published content can be obtained. For example, the portion of published content can be a web page, a web site, a portion of a web page, a portion of a web site, a portion of a graphic, a picture, a photograph, a portion of text, a portion of audio, a portion of video, a portion of a photograph, a document (e.g., word processing document, a graphic design document, a technical drawing document, a slide show document, etc.), a file (e.g., a thumbnail, a tile representation, etc.), a data file, an article, etc. At reference numeral 808, the personalization data can be utilized to graphically construct the portion of published content. It is to be appreciated that the graphically constructed portion of published content can be displayed or rendered by any suitable display engine, display component, video component (e.g., video card, etc.), and the like.

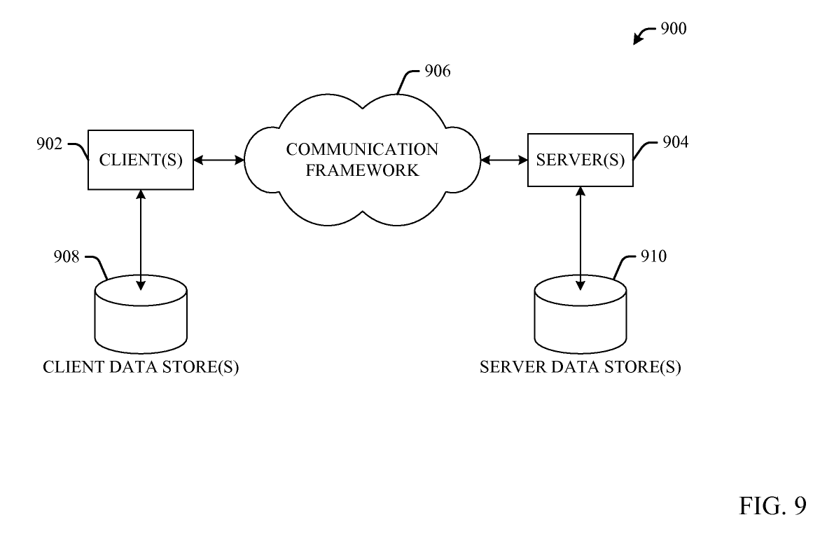

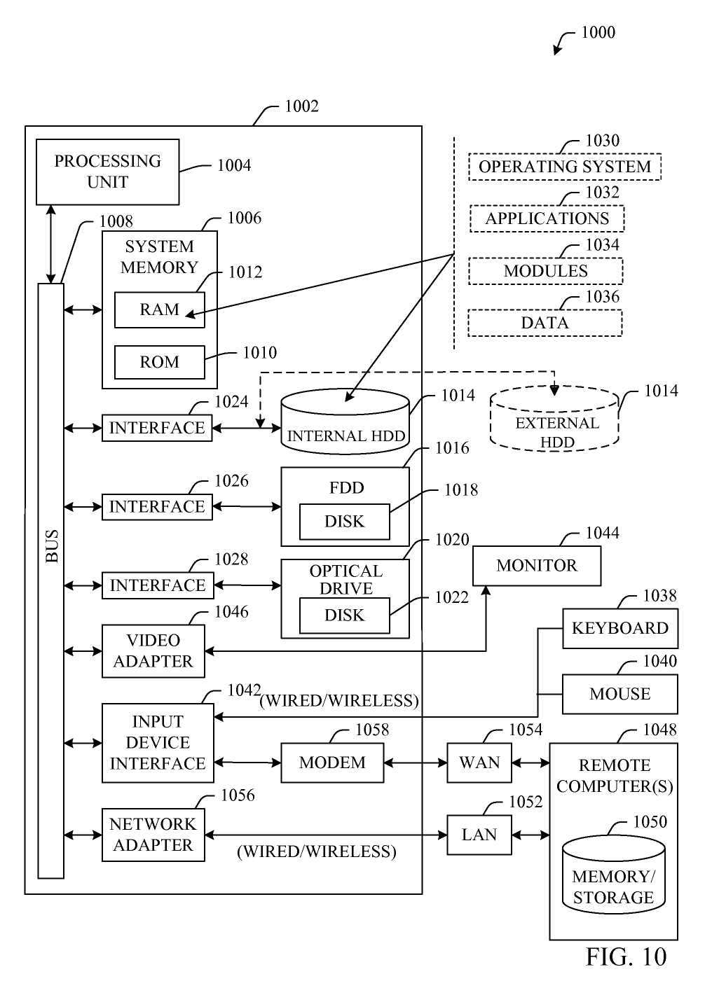

In order to provide additional context for implementing various aspects of the claimed subject matter, FIGS. 9-10 and the following discussion is intended to provide a brief, general description of a suitable computing environment in which the various aspects of the subject innovation may be implemented. For example, a personalization component can receive and enable display or rendering for viewable data based upon view-level display properties defined within personalization data, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 9 is a schematic block diagram of a sample-computing environment 900 with which the claimed subject matter can interact. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject innovation, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 950 that can be employed to store information local to the client(s) 910. Similarly, the server(s) 920 are operably connected to one or more server data store(s) 930 that can be employed to store information local to the servers 920.

With reference to FIG. 10, an exemplary environment 1000 for implementing various aspects of the claimed subject matter includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system that facilitates personalizing information, comprising:
a personalization component that generates personalization data for at least one user, the personalization data includes at least one display property associated with a portion of viewable data; and
a display engine that renders the portion of viewable data based at least in part on the personalization data.

2. The system of claim 1, the personalization component includes an obtainment component that collects information related to past patterns of the at least one user.

3. The system of claim 2, the obtainment component monitors at least one of frequency of interaction with a portion of viewable data or duration of interaction with a portion of viewable data.

4. The system of claim 3, the personalization component includes an analysis component that evaluates the collected information to determine at least one user preference of the at least one user.

5. The system of claim 4, further comprising a generation component that produces personalization data based at least in part on the at least one user preference,

6. The system of claim 5, the generation component associates at least one display property with a portion of viewable data in accordance with the user preference.

7. The system of claim 1, the at least one display property includes a definition to at least one of display or not display the portion of viewable data.

8. The system of claim 1, the at least one display property includes a definition related to a size/scale factor for the portion of viewable data.

9. The system of claim 1, the at least one display property is a resolution definition that indicates a display resolution for a portion of viewable data based upon the personalization data.

10. The system of claim 1, the at least one display property is a priority definition that dictates a hierarchical organization for the portion of viewable data.

11. The system of claim 1, the at least one display property is a reflow definition that automatically defines a setting related to adjusting the portion of viewable data to display within a viewing pane.

12. The system of claim 7, further comprising a reflow component that reflows the portion of viewable data utilizing the reflow definition, the reflow is a re-structured display layout for the portion of viewable data based upon at least one of a resizing or changing of display area.

13. The system of claim 1, the display engine enables at least one of a seamless pan or a zoom interaction with the portion of the viewable data, wherein such content includes one or more planes of view.

14. The system of claim 1, the viewable data includes a portion of image data that represents a computer displayable multi-scale image with at least two substantially parallel planes of view in which a first plane and a second plane are alternatively displayable based upon a level of zoom and which are related by a pyramidal volume, the multi-scale image includes the tag with at least one display property.

15. The system of claim 14, the second plane of view displays a portion of the first plane of view at one of a different scale or a different resolution based upon the personalization data that includes at least one display property.

16. The system of claim 14, the second plane of view displays a portion of the image data that is graphically or visually unrelated to the first plane of view based upon the personalization data that includes at least one display property.

17. The system of claim 14, the second plane of view displays a portion of the image data that is disparate than the portion of the image data associated with the first plan of view based upon the personalization data that includes at least one display property.

18. A computer-implemented method that facilitates providing personalized scaling of information, comprising:
obtaining personalization data related to a user, the personalization data includes at least one display property;
evaluating a portion of viewable data with respect to the personalization data; and
rendering the portion of viewable data based upon the at least one display property included in the personalization data.

19. The method of claim 18, the view-level display property is at least one of the following:
a definition related to a size/scale factor for the portion of viewable based;
a resolution definition that indicates a display resolution for a portion of viewable data; or
a priority definition that dictates a hierarchical organization for the portion of viewable data.

20. A computer-implemented system that facilitates rendering of a portion of viewable data, comprising:
means for monitoring past behavior of a at least one user;
means for determining at least one user preference based at least in part on past behavior;
means for producing personalization data in accordance with the user preference, the personalization data includes at least one display property corresponding to a portion of viewable data;
means for employing the personalization data to ascertain a view level of a portion of viewable data based at least in part on the display property; and
means for graphically rendering the portion of viewable data at the ascertained view-level.
